(19) United States
(12) Patent Application Publication
(10) Pub. No.: US 2018/0340130 A1
(43) Pub. Date: Nov. 29, 2018

(54) LUBRICANT COMPOSITION

(71) Applicants: NOK KLUEBER CO., LTD., Tokyo (JP); DENSO CORPORATION, Kariya (JP)

(72) Inventors: Wataru Sawaguchi, Kita Ibaraki-shi, Ibaraki (JP); Yusuke Asada, Kariya, Aichi (JP); Takahiro Nozu, Kariya, Aichi (JP); Takumi Shiomi, Kariya, Aichi (JP); Kyoji Inukai, Kariya, Aichi (JP)

(21) Appl. No.: 15/964,811

(22) Filed: Apr. 27, 2018

(30) Foreign Application Priority Data
May 26, 2017 (JP) 2017-105037

(51) Int. Cl. C10M 107/38; C10M 129/70; C10M 133/24; C10M 145/22; C10M 155/02

(52) U.S. Cl. CPC C10M 107/38; C10M 129/70; C10M 133/24; C10M 145/22; C10M 155/02; C10M 2207/28; C09J 4/00; C10M 2213/0606; C10M 2215/16; C10M 2229/02; C10N 2230/26; C10N 2240/202; C10M 2209/105

(57) ABSTRACT

A lubricant composition comprises a perfluoropolyether oil and an adhesive component.

### CROSS REFERENCE TO RELATED APPLICATIONS

The present application claims priority to Japanese Patent Application No. 2017-105037, filed on May 26, 2017. The contents of that application are incorporated herein by reference in their entirety.

### BACKGROUND

### Technical Field

The present disclosure relates to a lubricant composition, more particularly to a lubricant composition suitably used for a connection portion of a press-fit connector.

### Background Art

In recent years, automobiles have been equipped with various electronic devices which connect to external devices through a communication connector fixed on a circuit board. Since the connector is plugged when connecting the connector to the circuit board, insertion force applied tends to become large. Such being the case, it is required to reduce the insertion force when connecting the connector. Further, when the connector is in a connected state, it is required to retain a stable connection and also provide a low contact resistance characteristic.

For example, in Japanese Patent Application Laid-Open No. 2006-173059, there is disclosed a connector contact material comprising a coating film containing a mixture of fluororesin particles and fluorinated oil on a surface of a substrate as the connector contact material that has a small insertion force and does not raise a contact resistance value. Further, Japanese Patent Application Laid-Open No. 2009-16064 discloses a paste-form hardening resin which is applied to terminals when a terminal of a press-fit connector is inserted into a through hole.

However, while the connector contact material disclosed in Japanese Patent Application Laid-Open No. 2006-173059 achieves a reduction in the insertion force and low contact resistance, satisfactory retentivity between the connectors when the connectors are in the connected state is not achieved. Further, as for the paste-form hardening resin disclosed in Japanese Patent Application Laid-Open No. 2009-16064, there is not concretely disclosed the insertion force when the terminal is inserted into the through hole and the contact resistance while the terminal is inserted.

### SUMMARY

The present disclosure is related to providing a lubricant composition which reduces the insertion force on connecting a connector, and allows stably retaining the connection and also reducing contact resistance in a connected state of the connector when, for example, a press-fit connector is used for connecting the connector to a circuit board.

One aspect of the present disclosure relates to a lubricant composition comprising a perfluoropolyether oil and an adhesive component.

In accordance with one aspect of the present disclosure, the adhesive component includes at least one of 2-cyanoacrylate esters, (meth)acrylate esters, modified silicone resins, and epoxy resins.

In accordance with one aspect of the present disclosure, the content of the adhesive component is 3 to 60% by weight based on the total weight of the lubricant composition.

In accordance with one aspect of the present disclosure, the lubricant composition is used for a contact portion of an electrical connection part.

In accordance with one aspect of the present disclosure, the lubricant composition is used for a connection portion of a press-fit connector.

Using the lubricant composition according to one aspect of the present disclosure reduces the insertion force when connecting the connector, and allows stably retaining the connection and also reducing the contact resistance when the connector is in the connected state when, for example, a press-fit connector is used for connecting the connector to a circuit board.

### DETAILED DESCRIPTION

A lubricant composition according to an exemplary embodiment comprises a perfluoropolyether oil as a base oil and an adhesive component. Hereinafter, each component is described in detail.

### (Base Oil)

The base oil used in the exemplary embodiment is the perfluoropolyether oil. The perfluoropolyether oil may be linear or branched. A structure of the perfluoropolyether oil can be represented by the following general formula:

RfO(CF₂O)ₓ(C₂F₄O)_{y}(C₃F₆O)_{z}Rf

where CF₂O group, C₂F₄O group, and C₃F₆O group are randomly bonded in a main chain. More specifically, the structure of perfluoropolyether oil can be represented by the following general formulae (I) to (III). Alternatively, the structure may be a structure represented by the general formula (IV). Rf are each independently and are a perfluoro lower alkyl group having 1 to 5 carbon atoms, preferably 1 to 3 carbon atoms, such as a perfluoromethyl group, a perfluoroethyl group, and a perfluoropropyl group.

RfO[CF(CF₃)CF₂O]ₘRf (I)

where Rf represents the same as defined above, and m=2 to 200. The compound represented by the general formula (I) can be obtained by complete fluorination of a precursor produced by photooxidative polymerization of hexafluoropropylene. Alternatively, the compound represented by the general formula (I) can be obtained by anionic polymerization of hexafluoropropylene in the presence of a cesium fluoride catalyst, and treatment of the obtained acid fluoride compound containing a terminal-CF(CF₃)COF group with fluorine gas. Examples of the compound represented by the general formula (I) include C₃F₇O[CF(CF₃)CF₂O]ₘC₂F₅ where m=2 to 100.

RfO[CF(CF₃)CF₂O]ₚ(CF₂O)ₛRf (II)

where Rf represents the same as defined above, p+q=3 to 200, and p:q=10:90 to 90:10. The compound represented by the general formula (II) can be obtained by complete fluorination of a precursor produced by photooxidative polymerization of hexafluoropropene.

RfO(CF₂CF₂O)ᵣ(CF₂O)ₛRf (III)

where Rf represents the same as defined above, r+s=3 to 200, and r:s=10:90 to 90:10. The compound represented by the general formula (III) can be obtained by complete fluorination of a precursor produced by photooxidative polymerization of tetrafluoroethylene. Examples of the compound represented by the general formula (III) include CF₃O{(CF₂CF₂O)ᵣ(CF₂O)ₛ}CF₃ where r+s=40 to 180 and r/s=0.5 to 2.

F(CF₂CF₂CF₂O)ₙCF₂CF₃ (IV)

where n=2 to 100. The compound represented by the general formula (IV) can be obtained by anionic polymerization of 2,2,3,3-tetrafluorooxetane in the presence of a cesium fluoride catalyst, and treatment of the obtained fluorine-containing polyether (CF₂CF₂CF₂O)ₙ with fluorine gas under UV irradiation at 160 to 300° C.

The perfluoropolyether oil may be used singly or as a mixture of two or more. Kinetic viscosity of the perfluoropolyether oil at 40° C. is not limited to a particular value and is preferably 18 to 400 mm²/s. The kinetic viscosity can be measured in accordance with JIS K 2283.

According to the exemplary embodiment, the content of the perfluoropolyether oil is preferably 35 to 97% by weight, more preferably 40 to 90% by weight, based on the total weight of the lubricant composition. When the content of the perfluoropolyether oil is less than 35% by weight, contact resistance when the connector is in a connected state tends to become high. On the other hand, when the content of the perfluoropolyether oil is more than 97% by weight, retentivity when the connector is in the connected state tends to deteriorate.

### (Adhesive Component)

The term “adhesive component” used in the present disclosure includes not only a component exhibiting adhesive function by itself but also a component exhibiting adhesive function in combined use with a hardener or a curing catalyst, and the hardener and the curing catalyst are regarded as a part of the adhesive component. Examples of the adhesive component used in the exemplary embodiment include a thermoplastic resin, a thermosetting resin, and a rubber. In particular, the adhesive component preferably contains at least one of 2-cyanoacrylate esters, (meth)acrylate esters, modified silicone resins, and epoxy resins, and it is more preferable that a modified silicone resin is used in combination with the curing catalyst and an epoxy resin is used in combination with the hardener. In the exemplary embodiment, besides using a prescribed adhesive component alone, the prescribed adhesive component can be incorporated in the lubricant composition by using a commercially available adhesive. For example, when 2-cyanoacrylate ester is to be incorporated as the adhesive component, a commercially available cyanoacrylate adhesive containing 2-cyanoacrylate ester may be used. When (meth)acrylate ester is to be incorporated as the adhesive component, a commercially available acrylic resin adhesive containing (meth)acrylate ester may be used. When the modified silicone resin and the curing catalyst are to be incorporated as the adhesive component, a commercially available silicone adhesive containing the modified silicone resin and the curing catalyst may be used. When the epoxy resin and the hardener are to be incorporated as the adhesive component, a commercially available epoxy resin adhesive containing the epoxy resin and a commercially available hardener that is used in combination with the epoxy resin adhesive may be used. The content of the adhesive component contained in a commercially available adhesive is preferably 80% by weight or more, more preferably 90% by weight or more.

Examples of 2-cyanoacrylate ester include alkyl 2-cyanoacrylate and alkoxyalkyl 2-cyanoacrylate. More particularly, alkyl 2-cyanoacrylate refers to methyl 2-cyanoacrylate, ethyl 2-cyanoacrylate, n-propyl 2-cyanoacrylate, n-butyl 2-cyanoacrylate, n-pentyl 2-cyanoacrylate, hexyl 2-cyanoacrylate, and cyclohexyl 2-cyanoacrylate. More particularly, alkoxyalkyl 2-cyanoacrylate refers to methoxyethyl 2-cyanoacrylate, methoxybutyl 2-cyanoacrylate, ethoxyethyl 2-cyanoacrylate, ethoxypropyl 2-cyanoacrylate, ethoxyisopropyl 2-cyanoacrylate, propoxymethyl 2-cyanoacrylate, propoxyethyl 2-yanoacrylate, and propoxypropyl 2-cyanoacrylate. Among the above, alkyl 2-cyanoacrylate is preferably used, and ethyl 2-cyanoacrylate is more preferably used in terms of its stable adhesion properties. 2-cyanoacrylate ester may be used singly or as a mixture of two or more.

Examples of (meth)acrylate ester include methyl (meth)acrylate, ethyl (meth)acrylate, propyl (meth)acrylate, n-butyl (meth)acrylate, t-butyl (meth)acrylate, n-hexyl (meth)acrylate, 2-ethylhexyl (meth)acrylate, n-octyl (meth)acrylate, lauryl (meth)acrylate, cyclohexyl (meth)acrylate, phenyl (meth)acrylate, naphthyl (meth)acrylate, 2-methoxyethyl (meth)acrylate, ethoxyethyl (meth)acrylate, 2-aminoethyl (meth)acrylate, N,N-dimethylaminoethyl (meth)acrylate, N,N-diethylaminoethyl (meth)acrylate, 2-hydroxyethyl (meth)acrylate, glycidyl (meth)acrylate, and tetrahydrofurfuryl (meth)acrylate. The (meth)acrylate ester may be used singly or as a mixture of two or more.

Examples of the modified silicone resin include an oxyalkylene polymer containing a terminal reactive silyl group and an acrylic polymer containing a terminal reactive silyl group. The modified silicone resin may be used singly or as a mixture of two or more. Examples of the curing catalyst that is used in combination with the modified silicone resin include a tin compound.

Examples of the epoxy resin include a bisphenol A-type epoxy resin and a bisphenol F-type epoxy resin. The epoxy resin may be used singly or as a mixture of two or more. Examples of the hardener that is used in combination with the epoxy resin include aliphatic amines such as diethylenetriamine, triethylenetetramine, tetraethylenepentamine, diethylaminopropylamine, and N-aminoethylpiperazine, aromatic amines such as metaphenylenediamine, diaminodiphenylmethane, and diaminodiphenylsulfone, and polyamide resins such as polyamide amine.

In the exemplary embodiment, the content of the adhesive component is preferably 3 to 60% by weight, more preferably 10 to 50% by weight, based on the total weight of the lubricant composition. When the content of the adhesive component is less than 3% by weight, the retentivity when the connector is in the connected state tends to deteriorate. On the other hand, the content of the adhesive component is more than 60% by weight, the contact resistance when the connector is in the connected state tends to become high.

The lubricant composition according to the exemplary embodiment may further contain an additive to such an extent that the additive does not affect the effectiveness of the lubricant composition. For example, the additive can be appropriately selected from a thickener, an anticorrosive agent, a surfactant, or the like and included in the lubricant composition.

The thickener has a role to improve dispersibility of the perfluoropolyether oil and the adhesive component. Examples of the thickener include polytetrafluoroethylene (hereinafter, referred to as PTFE). PTFE in a powdery form is preferably used. An average particle diameter of PTFE is preferably 0.2 to 10 μm. The average particle diameter can be directly measured with an electron microscope. PTFE can be used singly or as a mixture of two or more having different average particle diameters.

In the exemplary embodiment, the content of PTFE is preferably 5 to 25% by weight, more preferably 5 to 15% by weight, based on the total weight of the lubricant composition. When the content of PTFE is less than 5% by weight, the adhesive component is not uniformly dispersed in the lubricant composition and thus the retentivity when the connector is in the connected state tends to deteriorate. On the other hand, when the content of PTFE is more than 25% by weight, a large amount of PTFE intervenes into the connection part of the connector and thus the retentivity when the connector is in the connected state tends to deteriorate.

When the lubricant composition according to the exemplary embodiment is applied to a coating object, a coating film is formed. When the lubricant composition is applied to the coating object, the adhesive component solidifies firmly in a short time. A thickness of the coating film is preferably 50 to 500 μm in order to show an advantageous effect of the lubricant composition according to the exemplary embodiment.

The lubricant composition according to the exemplary embodiment contains the perfluoropolyether oil and the adhesive component. Use of such a lubricant composition can reduce the insertion force of the connector when connecting the connector, and provides low contact resistance and excellent retentivity when the connector is in the connected state. Further, when the lubricant composition according to the exemplary embodiment is applied to the coating object, it adheres to the coating object firmly in a short time since the lubricant composition contains the adhesive component. Accordingly, a drying time after the lubricant composition is applied can be shortened. A drying temperature is not limited to a particular temperature and is 20 to 40° C., for example. It is not necessary to dry the applied lubricant composition at high temperatures. A drying time is preferably 2 to 4 hours.

The lubricant composition according to the exemplary embodiment is preferably used for a contact portion of an electrical connection part, particularly for a connection portion of a press-fit connector.

### Examples

Hereinafter, preferred embodiments of the present disclosure are specifically described with reference to Examples and Comparative Examples. However, the present disclosure is not limited to these Examples.

### (1) Method for Preparing Lubricant Composition

The lubricant composition was prepared by mixing a base oil, a thickener, and an adhesive in such a manner that each component had a content (% by weight) shown in Tables 1 to 3.

### <Base Oil>

Perfluoropolyether oil A: Kinetic viscosity at 40° C. of 25 mm²/s which is represented by C₃F₇O[CF(CF₃)CF₂O]ₘC₂F₅ of the formula (I), where m=2 to 100.

Perfluoropolyether oil B: Kinetic viscosity at 40° C. of 100 mm²/s which is represented by C₃F₇O[CF(CF₃)CF₂O]ₘC₂F₅ of the formula (I), where m=2 to 100.

Perfluoropolyether oil C: Kinetic viscosity at 40° C. of 400 mm²/s which is represented by C₃F₇O[CF(CF₃)CF₂O]ₘC₂F₅ of the formula (I), where m=2 to 100.

Perfluoropolyether oil D: Kinetic viscosity at 40° C. of 17 mm²/s which is represented by CF₃O{(CF₂CF₂O)ᵣ(CF₂O)ₛ}CF₃ of the formula (III), where r+s=40 to 180 and r/s=0.5 to 2.

Perfluoropolyether oil E: Kinetic viscosity at 40° C. of 1200 mm²/s which is represented by C₃F₇O[CF(CF₃)CF₂O]ₘC₂F₅ of the formula (I), where m=2 to 100.

### <Thickener>

PTFE A: Polytetrafluoroethylene having an average particle diameter of 0.1 to 0.2 μm

PTFE B: Polytetrafluoroethylene having an average particle diameter of 3 to 5 μm

### <Adhesive>

Adhesive A: A cyanoacrylate adhesive, a product name of “Aron Alpha #203TX” manufactured by Toagosei Co., Ltd.

Adhesive B: An acrylic resin adhesive, a product name of “ThreeBond 1360F” manufactured by ThreeBond Fine Chemical Co., Ltd.

Adhesive C: A modified silicone adhesive, a product name of “Cemedine Super-X2 clear” manufactured by Cemedine Co., Ltd.

Adhesive D: An epoxy resin adhesive, a product name of “ThreeBond 2088E” (including a base agent and a hardener) manufactured by ThreeBond Fine Chemical Co., Ltd.

The base agent and the hardener were used at a ratio of 4:1 (ratio by weight).

### <Additive>

Ag powder: An average particle diameter of 6 to 7 μm (in a flake form)

### (2) Evaluation Method

### (2-1) Insertion Force

An insertion test was conducted using an Autograph (a product name of “EZ-SX” manufactured by Shimadzu Corporation). First, a substrate having a hole with a diameter of 1 mm and a terminal having an outside dimension of 1.2 mm were prepared. Next, a prepared lubricant composition was applied to the terminal. The substrate was fixed with a substrate fixing jig of the Autograph and the terminal was fixed with a terminal holding jig so that the terminal could be inserted into the hole provided on the substrate. The terminal was inserted into the hole provided on the substrate at a rate of 120 mm/min. A maximum force required for the insertion was determined as the insertion force. A percentage of the insertion force when the lubricant composition was applied with respect to the insertion force when the lubricant composition was not applied (percentage relative to uncoated control) was determined. The percentage being 90% or less was determined as “Good” and the percentage of more than 90% was determined as “Poor.” “Good” was regarded as an acceptable level.

### (2-2) Contact Resistance

After the insertion test, the tested object with the terminal being inserted into the hole provided on the substrate was dried at 40° C. for 3 hours. A wiring soldered to the substrate and the terminal inserted into the substrate were each gripped with an IC clip, and then contact resistance was measured using a low resistance meter (a product name of “Model 3569” manufactured by Tsuruga Electric Corporation) at a measuring range of 30 mΩ. As for the contact resistance, a value of less than 100μΩ was determined as “Very good,” a value of 100μΩ or more and less than 200μΩ was determined as “Good,” and a value of 200μΩ or more was determined as “Poor.” “Very good” and “Good” were regarded as acceptable levels.

### (2-3) Retentivity

After the contact resistance was measured, a withdrawal test was conducted. The terminal inserted into the substrate was withdrawn at a rate of 12 mm/min, and a maximum value of force required for the withdrawal was determined as withdrawal force. The retentivity was evaluated according to values of the withdrawal force. A percentage of the withdrawal force when the lubricant composition was applied with respect to the withdrawal force when the lubricant composition was not applied (percentage relative to uncoated control) was determined. The percentage being 70% or more was determined as “Very good,” the percentage being 48% or more and less than 70% was determined as “Good,” and the percentage being less than 48% was determined as “Poor.” “Very good” and “Good” were regarded as acceptable levels.

### (3) Evaluation Results

Evaluation results are shown in Tables 1 to 3.

TABLE 1

| | Exam- | Exam- | Exam- | Exam- | Exam- | Exam- | Exam- | Exam- | Exam- | Exam- |
|---|---|---|---|---|---|---|---|---|---|---|
| | ple 1 | ple 2 | ple 3 | ple 4 | ple 5 | ple 6 | ple 7 | ple 8 | ple 9 | ple 10 |
| Perfluoropolyether oil A | | | 48 | | | | 52 | | 60 | |
| Perfluoropolyether oil B | 61 | | | 88 | | | | 63 | | |
| Perfluoropolyether oil C | | 42 | | | 70 | | | | | |
| Perfluoropolyether oil D | | | | | | 85 | | | | |
| Perfluoropolyether oil E | | | | | | | | | | 88 |
| PTFE A | 7 | 20 | | | | | | | | |
| PTFE B | | | 7 | | | | | | | |
| Adhesive A | 32 | 38 | 45 | | | | | | | |
| Adhesive B | | | | 12 | 30 | 15 | | | | 12 |
| Adhesive C | | | | | | | 48 | 37 | | |
| Adhesive D | | | | | | | | | 40 | |
| Total | 100 | 100 | 100 | 100 | 100 | 100 | 100 | 100 | 100 | 100 |
| Insertion force (percentage relative | 80 | 78.8 | 85 | 77.5 | 80 | 77.5 | 84 | 79 | 82 | 74 |
| to uncoated control, %) | Good | Good | Good | Good | Good | Good | Good | Good | Good | Good |
| Withdrawal force (percentage | 88 | 96 | 120 | 130 | 174 | 156 | 80 | 76 | 80 | 124 |
| relative to uncoated control, %) | Very | Very | Very | Very | Very | Very | Very | Very | Very | Very |
| | good | good | good | good | good | good | good | good | good | good |
| Contact resistance (μΩ) | 90 | 95 | 98 | 75 | 86 | 78 | 98 | 93 | 97 | 99 |
| | Very | Very | Very | Very | Very | Very | Very | Very | Very | Very |
| | good | good | good | good | good | good | good | good | good | good |

TABLE 2

| | Example 11 | Example 12 | Example 13 | Example 14 | Example 15 |
|---|---|---|---|---|---|
| Perfluoropolyether oil A | 78 | 37 | | | |
| Perfluoropolyether oil B | | | 95 | 45 | |
| Perfluoropolyether oil D | | | | | 95 |
| PTFE A | 15 | 8 | | | |
| Adhesive A | 7 | 55 | | | |
| Adhesive B | | | 5 | 55 | 5 |
| Total | 100 | 100 | 100 | 100 | 100 |
| Insertion force (percentage relative | 78 | 82.5 | 82 | 85 | 89 |
| to uncoated control, %) | Good | Good | Good | Good | Good |
| Withdrawal force (percentage | 50 | 160 | 66 | 200 | 62 |
| relative to uncoated control, %) | Good | Very good | Good | Very good | Good |
| Contact resistance (μΩ) | 90 | 180 | 65 | 140 | 75 |
| | Very good | Good | Very good | Good | Very good |

TABLE 3

| | Comparative | Comparative | Comparative | Comparative | Comparative | Comparative | Comparative | Comparative |
|---|---|---|---|---|---|---|---|---|
| | Example 1 | Example 2 | Example 3 | Example 4 | Example 5 | Example 6 | Example 7 | Example 8 |
| Perfluoropolyether oil A | | | | | | | | |
| Perfluoropolyether oil B | 100 | | | | | | | |
| Perfluoropolyether oil C | | 100 | | | | | | |
| PTFE B | | | | 50 | | | | |
| Adhesive A | | | 100 | 50 | | | | 80 |
| Adhesive B | | | | | 100 | | | |
| Adhesive C | | | | | | 100 | | |
| Adhesive D | | | | | | | 100 | |
| Ag powder | | | | | | | | 20 |
| Total | 100 | 100 | 100 | 100 | 100 | 100 | 100 | 100 |
| Insertion force (percentage relative | 75 | 69 | 92.5 | 80 | 91 | 91 | 92.5 | 95 |
| to uncoated control, %) | Good | Good | Poor | Good | Poor | Poor | Poor | Poor |
| Withdrawal force (percentage | 46 | 46 | 270 | 140 | 320 | 100 | 130 | 250 |
| relative to uncoated control, %) | Poor | Poor | Very good | Very good | Very good | Very good | Very good | Very good |
| Contact resistance (μΩ) | 40 | 45 | 280 | 235 | 300 | 120 | 190 | 230 |
| | Very good | Very good | Poor | Poor | Poor | Good | Good | Poor |

According to Table 1 and Table 2, the perfluoropolyether oil and the adhesive component were contained in Examples 1 to 15. Thus, the insertion force was small when inserting the terminal into the substrate, the contact resistance was low which was measured while the terminal was inserted into the substrate, and also the withdrawal force was large when withdrawing the terminal from the substrate. Accordingly, it was found that the retentivity was excellent while the terminal was inserted into the substrate. In Examples 1 to 10 in particular, since the content of the adhesive component was 10 to 50% by weight based on the total weight of the lubricant composition, it was found that the insertion force, the withdrawal force, and the contact resistance were better in these cases.

On the other hand, in Comparative Examples 1 and 2 according to Table 3, the adhesive component was not contained. Thus, it was found that the withdrawal force was small when withdrawing the terminal and the retentivity was poor while the terminal was inserted.

In Comparative Examples 3 and 5, the perfluoropolyether oil was not contained. Thus, the insertion force was large when inserting the terminal into the substrate and the contact resistance was high while the terminal was inserted. Accordingly, the lubricant compositions in these cases were regarded as not practical for use.

In Comparative Example 4, the perfluoropolyether oil was not contained. Thus, the contact resistance was high while the terminal was inserted. Accordingly, the lubricant composition in this case was regarded as not practical for use.

In Comparative Examples 6 and 7, the perfluoropolyether oil was not contained. Thus, it was found that the insertion force was large when inserting the terminal into the substrate.

In Comparative Example 8, although the Ag powder was contained, the perfluoropolyether oil was not contained. Thus, the insertion force was large when inserting the terminal into the substrate and the contact resistance was high while the terminal was inserted. Accordingly, the lubricant composition in this case was regarded as not practical for use.

According to the above, the lubricant composition according to the exemplary embodiment comprises the perfluoropolyether oil and the adhesive component, which reduces the insertion force when connecting the connector, and allows stably retaining the connection and also reducing the contact resistance when the connector is in the connected state.

The lubricant composition according to the exemplary embodiment can be employed in a car industry, a machine industry, and an electrical and electronic industry using a connector, more particularly a press-fit connector.

What is claimed is:

1. A lubricant composition comprising a perfluoropolyether oil and an adhesive component.

2. The lubricating composition according to claim 1, wherein the adhesive component comprises at least one of 2-cyanoacrylate esters, (meth)acrylate esters, modified silicone resins, and epoxy resins.

3. The lubricant composition according to claim 1, wherein a content of the adhesive component is 3 to 60% by weight based on a total weight of the lubricant composition.

4. The lubricant composition according to claim 2, wherein a content of the adhesive component is 3 to 60% by weight based on a total weight of the lubricant composition.

5. The lubricant composition according to claim 1, wherein the lubricant composition is used for a contact portion of an electrical connection part.

6. The lubricant composition according to claim 2, wherein the lubricant composition is used for a contact portion of an electrical connection part.

7. The lubricant composition according to claim 3, wherein the lubricant composition is used for a contact portion of an electrical connection part.

8. The lubricant composition according to claim 4, wherein the lubricant composition is used for a contact portion of an electrical connection part.

9. The lubricant composition according to claim 1, wherein the lubricant composition is used for a connection portion of a press-fit connector.

10. The lubricant composition according to claim 2, wherein the lubricant composition is used for a connection portion of a press-fit connector.

11. The lubricant composition according to claim 3, wherein the lubricant composition is used for a connection portion of a press-fit connector.

12. The lubricant composition according to claim 4, wherein the lubricant composition is used for a connection portion of a press-fit connector.
